(19) United States
(12) Patent Application Publication
(10) Pub. No.: US 2026/0035872 A1
(43) Pub. Date: Feb. 5, 2026

(54) Mass-Optimized Geogrid for Regolith and Soil Stabilization in Extraterrestrial and Extreme Earth Environments

(71) Applicant: David Iwami Malott, TANNER, AL (US)

(72) Inventors: David Iwami Malott, TONEY, AL (US); Connor McLeod, MADISON, AL (US); Leonel Herrera, HUNTSVILLE, AL (US); Austin Hacker, HUNTSVILLE, AL (US)

(73) Assignee: SpaceFactory Inc., TANNER, AL (US)

(21) Appl. No.: 19/353,435

(22) Filed: Oct. 8, 2025

Related U.S. Application Data
(60) Provisional application No. 63/705,042, filed on Oct. 9, 2024.

(51) Int. Cl. E02D 3/00; B64G 99/00

(52) U.S. Cl. CPC E02D 3/005; B64G 99/00

(57) ABSTRACT

This invention relates to a mass-optimized geogrid system and method for stabilizing regolith and other granular soils in extraterrestrial and extreme Earth environments. Mass reduction is achieved both locally—within individual geogrid layers through optimization of lattice geometry, variable mesh density, and reinforcement at stress concentrations—and globally, by varying the spacing and distribution of layers according to structural demands. The geogrid may be fabricated from materials that are locally sourced or compositionally traceable to in-situ resource utilization (ISRU) processes in environments such as the Moon, Mars, or terrestrial polar and desert regions where conventional construction materials are limited or costly to transport. The method includes restructuring the regolith by size-sorting and compaction to produce a particle-size distribution proportionally matched to the mesh openings, enhancing mechanical interlock and shear resistance. Structural efficiency can be tuned and verified through physical testing and finite-element analysis for scalable, repeatable construction.

### CROSS-REFERENCE TO RELATED APPLICATIONS

This application claims the benefit under 35 U.S.C. § 119(e) of U.S. Provisional Patent Application No. 63/705,042, filed 9 Oct. 2024, entitled “Mass-Optimized Geogrid for Regolith Stabilization in Lunar and Extraterrestrial Environments,” the entire disclosure of which is incorporated herein by reference.

### STATEMENT REGARDING FEDERALLY SPONSORED RESEARCH OR DEVELOPMENT

This invention was made with government support under Contract Nos. 80NSSC23PB578 and 80NSSC25CA035 awarded by the National Aeronautics and Space Administration. The government has certain rights in the invention.

### FIELD OF THE INVENTION

The present invention relates to geotechnical reinforcement systems, and more particularly to mass-optimized geogrid structures configured to stabilize regolith and soil in extraterrestrial environments such as the Moon, Mars, and asteroids. The invention also applies to extreme Earth environments including deserts and polar regions. It addresses the stabilization of granular substrates for infrastructure development using materials that can be locally sourced or synthesized in situ, particularly where conventional materials are limited or costly to transport.

### BACKGROUND TO THE INVENTION

In extraterrestrial environments such as the Moon and Mars, regolith is a desirable construction material due to its abundance. However, in its natural state, it lacks the necessary strength for construction applications. Eons of meteorite impact and extreme thermal cycling have transformed the bulk of surface materials into fine, loose particles which lack cohesion and stability. These factors, combined with the absence of organic material and moisture, make the regolith a challenging material for building robust lunar infrastructure.

Other regolith-based construction methods, such as sintering or regolith polymer composite extrusion, either require significant energy or rely on a large percentage of externally sourced binders, rendering them impractical for large-scale infrastructure. These methods are better suited for focused applications due to their limited scalability and high resource demands. In contrast, the geogrid system introduced here offers a low-energy, scalable solution with minimal additional mass (<2%), capable of addressing a wide range of lunar construction needs.

While mass-optimization in geogrid systems is not typically considered for terrestrial applications due to the complexity and cost of manufacturing, this principle is critical for space-based construction. By incorporating mass-optimized designs and space-relevant materials, the present invention offers substantial savings in both cost and energy for extraterrestrial infrastructure, making it an efficient solution for construction in resource-limited environments.

In prior work by the inventors, U.S. patent application Ser. No. 18/634,888, titled “Materials, Methods, and Apparatus for Lunar Engineered Regolith”, a comprehensive system for enhancing lunar regolith was introduced. The previous invention detailed methods for improving regolith cohesion, shear strength, and bearing capacity through the use of polymer additives, mesh reinforcement, and compaction techniques. While that system significantly advanced the field of lunar construction, the present invention builds upon these foundational strategies by specifically focusing on a geogrid system for enhanced stabilization and reinforcement of regolith-based infrastructures.

### BRIEF SUMMARY OF THE INVENTION

The present invention introduces a mass-optimized geogrid system for stabilizing regolith in lunar environments, wherein the geogrid may be fabricated from materials that can be locally sourced or transported from Earth, depending on mission requirements and resource availability. The system improves structural performance while minimizing material usage and can be adapted for various infrastructure applications, including launch pads, landing pads, and load-bearing structures. Although optimized for lunar deployment, the system and underlying principles are applicable to other extraterrestrial and extreme Earth environments.

The geometric design of the geogrid is engineered to optimize material efficiency while maintaining structural performance. Unlike terrestrial geogrids, which typically employ uniform patterns due to cost and manufacturing simplicity, the present system employs precision-engineered geometries that may include localized features such as triangular lattice patterns, variable mesh densities, thickened members, or reinforced borders. These features allow material to be concentrated where stress is greatest and minimized where loads are lower, contributing to overall mass efficiency.

The geogrid operates in combination with a regolith restructuring process to improve the interaction between the grid and the regolith substrate. In this process, the regolith is size-sorted to remove excess fines (typically particles smaller than 0.5-1.0 mm), producing a mixture in which the larger grains correspond in scale to the openings—or “windows”—of the geogrid mesh. When the particle size and window size are proportionally matched, the particles partially penetrate and bear against the edges of the openings, creating a mechanical interlock that enhances frictional resistance along the grid plane.

When embedded between compacted regolith layers, the geogrid resists shear deformation along potential slip planes by mobilizing this interlock, thereby increasing the apparent shear strength of the reinforced layer. When positioned along an outer surface, the same interlocking effect provides lateral confinement, preventing particle displacement and stabilizing the structure. In both configurations, stresses are redistributed toward the perimeter confinement, improving overall stability and load-bearing capacity.

Structural efficiency and material allocation within the regolith body can be determined using Finite Element Analysis (FEA) or equivalent computational modeling. These analyses identify regions of higher and lower stress, allowing grid density, thickness, and layer spacing to be selectively increased where reinforcement is required and reduced where loads are minimal. This model-based approach enables hierarchical optimization—at both the component level of the grid and the system level of the reinforced regolith structure—achieving an optimal balance between strength and mass tailored to each application.

The geogrid can be fabricated or assembled in situ from pre-formed sheets, rolled materials, or additively manufactured segments, reducing reliance on Earth-supplied materials. Deployment may be performed autonomously by robotic systems capable of dispensing, positioning, and interlocking the grids with minimal human supervision. This autonomous capability enables scalable construction in hazardous or remote environments, distinguishing the system from conventional terrestrial geogrid methods.

The resulting system is applicable to a broad range of extraterrestrial and terrestrial infrastructure, including roads, landing pads, embankments, foundations, and load-bearing walls for habitats. Through its combination of mesh optimization, local resource utilization, autonomous deployment, and analytical framework, the invention provides a scalable means for constructing mass- and energy-efficient structures in environments where conventional building methods are impractical.

### BRIEF DESCRIPTION OF THE SEVERAL VIEWS OF THE DRAWING

FIG. 1 illustrates various configurations of geogrid structures designed for reinforcing granular regolith.

FIG. 2 illustrates rectilinear variations of the geogrid, demonstrating adaptability between circular, square, and other geometric formats.

FIG. 3 illustrates the process by which a flat geogrid is folded to form a three-dimensional geogrid.

FIG. 4 illustrates an exemplary forming process in which flat sheet feedstock is progressively folded by contoured rollers to create upturned sidewalls, forming a continuous three-dimensional geogrid.

FIG. 5 illustrates unstructured bulk regolith and restructured regolith, characterizing differences in particle size distribution and packing density.

FIG. 6 illustrates the interaction between geogrids and both bulk and restructured regolith, showing mechanical interlock relative to particle size and mesh window geometry.

FIG. 7 illustrates the output of a finite element analysis (FEA) performed on a representative regolith embankment, showing regions of stress and localized stress concentrations.

FIG. 8 illustrates the corresponding physical regolith-based embankment, in which geogrid reinforcement levels are informed by the FEA results.

FIG. 9, previously disclosed in U.S. patent application Ser. No. 18/634,888, illustrates foundational infrastructures constructed using engineered regolith reinforced by the geogrid system.

FIG. 10, also from U.S. patent application Ser. No. 18/634,888, illustrates an integrated surface architecture incorporating a lunar vault and vertical geogrid reinforcement, highlighting its differentiation from the prior disclosure.

### DETAILED DESCRIPTION OF THE INVENTION

Geogrid Geometry. The geogrid's geometric pattern is governed by the efficient use of mass and may be adapted to the characteristics of the substrate, the form factor and load conditions of the supported structure, and environmental influences such as vacuum, reduced gravity, thermal cycling, seismic activity, and micrometeorite impacts. Unlike conventional terrestrial geogrids, which typically employ uniform lattice geometries for ease of production and cost efficiency, the present system prioritizes structural performance relative to mass. Terrestrial applications rarely justify the added engineering and manufacturing complexity required for geometric optimization, since material transport costs and energy budgets are comparatively low. In contrast, extraterrestrial and remote environments impose severe mass and energy constraints, making every unit of material significant. Accordingly, the geogrid's geometry is designed to minimize mass while maintaining or exceeding the structural performance of uniform-mesh counterparts.

In some examples, the infill pattern is triangulated to enhance structural efficiency, leveraging the inherent rigidity of triangular lattices to distribute loads uniformly across the grid. In other examples, reinforcement is added selectively in regions of higher stress by thickening specific grid members or increasing local mesh density, ensuring that critical zones receive added support without unnecessary weight across the entire structure. Conversely, in regions of lower stress, portions of the infill pattern may be thinned or omitted to further reduce mass, producing a lightweight design tailored to the predicted stress distribution. In some examples, the geogrid includes reinforced bracing lines or radial ribs connecting a central opening to a reinforced perimeter to enhance structural continuity throughout the plane of the grid.

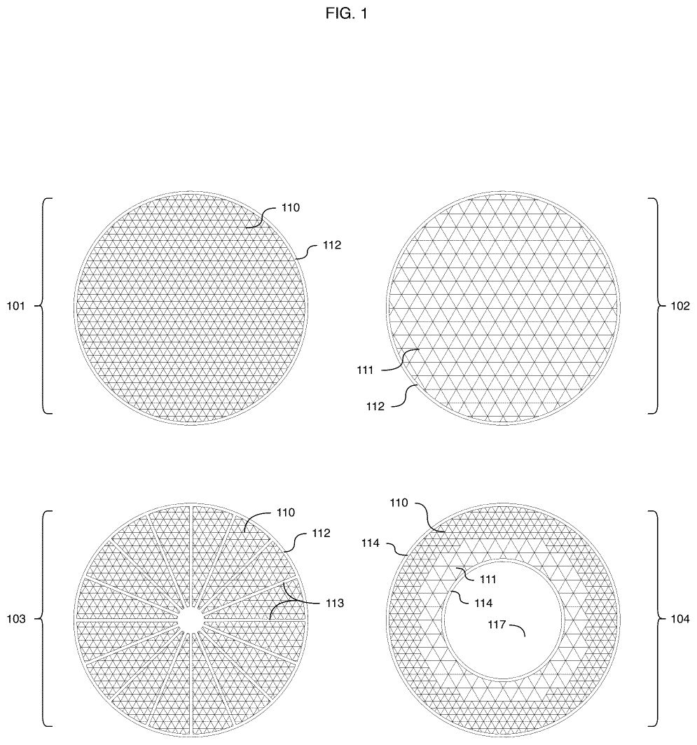

Several examples of geogrid configurations are illustrated in FIG. 1. Example 101 shows a dense triangular lattice (110) bounded by a reinforced perimeter (112) providing uniform load distribution. Example 102 illustrates a sparse triangular pattern (111) for reduced mass where lower stresses are expected. Example 103 includes a dense triangular lattice (110) in combination with radial bracing members (113) extending from the center to the reinforced perimeter (112), enhancing in-plane stiffness and distributing a point load symmetrically. Example 104 shows a variant having both a reinforced border (112) and an internal aperture (117) with a reinforced collar (114), suitable for integration around anchoring elements or conduits. These variations demonstrate how the geogrid geometry can be adapted to different structural requirements while maintaining the fundamental principle of mass efficiency through selective reinforcement.

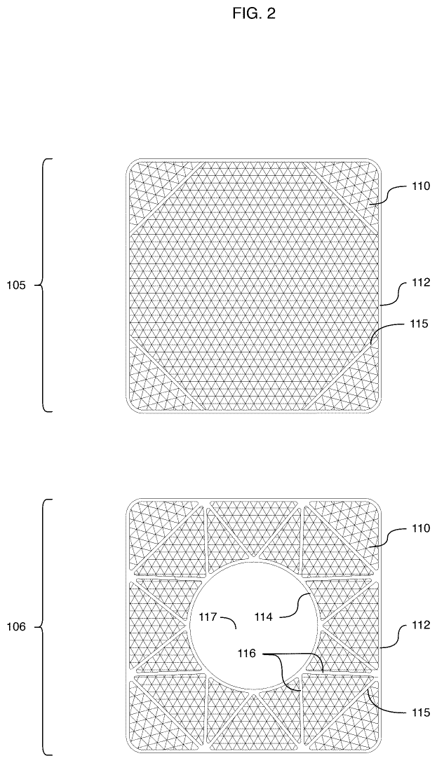

Additional examples of geogrid configurations are illustrated in FIG. 2. Example 105 depicts a rectilinear geogrid comprising a dense triangular lattice (110) bounded by a reinforced perimeter (112) with corner bracing members (115) that maintain overall stiffness. Example 106 depicts a similar rectilinear form with the addition of an internal aperture (117) and diagonal bracing members (116) connecting the reinforced collar (114) to the reinforced perimeter (112). These examples demonstrate that the mass-optimized lattice principles applied to circular geogrids (FIG. 1) are adaptable to rectilinear and other geometric formats, enabling integration into diverse surface or structural applications.

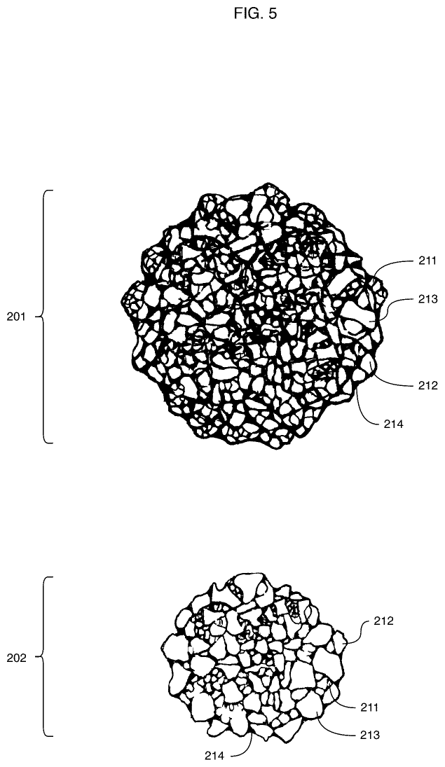

Mesh-Regolith Interaction. As illustrated in FIG. 5, bulk regolith (201) represents the natural, unprocessed state of the substrate, containing a wide distribution of particle sizes, including large particles (213) ranging from approximately 1.0 mm to 2.0 mm in diameter, medium particles (212) between about 0.5 mm and 1.0 mm, and regolith fines (211) smaller than approximately 0.5 mm, separated by interstitial voids (214). Restructured regolith (202) depicts material in which the particle-size distribution has been selectively modified through size-sorting to remove regolith fines, followed by a compaction process to reduce void space and improve packing density. During this process, approximately 40-60% of the regolith fines are reintroduced and compacted to fill the interstitial voids. This gradation control enhances performance when used with the present geogrid system, providing a predictable interface geometry for mechanical interlock.

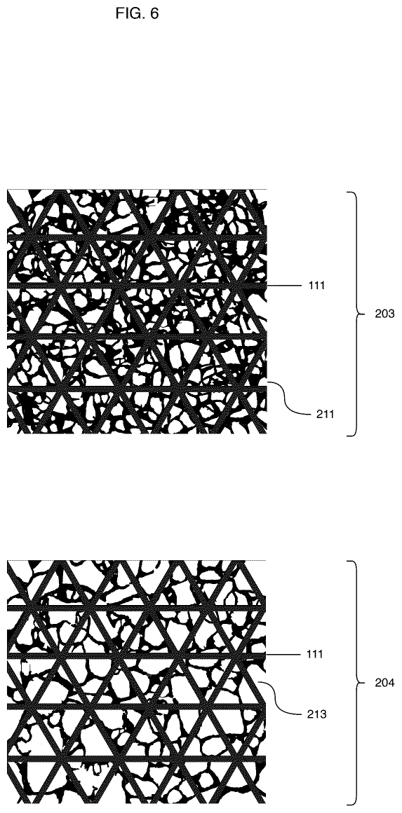

As illustrated in FIG. 6, Example 203 shows bulk regolith (201) overlaid with a triangular mesh (111), while Example 204 depicts restructured regolith (202) overlaid with the same mesh. In the optimized configuration, the characteristic particle size of the restructured regolith corresponds proportionally to the mesh window opening, which in some examples may be approximately 2.0 mm. Matching the particle scale to the window dimension enables individual grains to bear against the mesh edges, reducing slip and increasing shear resistance along the grid plane. This relationship between regolith gradation and mesh geometry provides the structural rationale for the improved stability and mass efficiency observed in the geogrid-reinforced system.

Regolith Restructuring. The restructuring of regolith described in FIGS. 5 and 6 may be achieved through any process that selectively sorts and compacts substrate particles to align the effective particle size with the mechanical scale of the geogrid mesh. Suitable methods may include sieving, vibration compaction, and blending of fines to fill interstitial voids between coarser particles. This proportional alignment improves interlocking between the regolith and the mesh while avoiding the need for excessively fine or mass-intensive grid members. The process may be implemented as a stand-alone substrate preparation step or integrated into the geogrid installation sequence.

Materials and Composition. The geogrid may be constructed from materials that are locally sourced or compositionally traceable to in-situ resource utilization (ISRU) processes anticipated for future missions. This approach enables the same material systems to be produced on Earth for early deployment and later replicated using extraterrestrial feedstocks, establishing a consistent supply chain from terrestrial to off-world manufacturing. The selected materials may exhibit resistance to environmental extremes, maintaining mechanical stability after prolonged exposure to vacuum, cryogenic and elevated temperatures, repeated thermal cycling, radiation (solar ultraviolet and cosmic), and abrasion from dust. In some cases, the materials are chosen to support additive manufacturing, casting, or hybrid forming methods, enabling efficient in-situ fabrication. Suitable material classes may include basalt fibers extruded from molten regolith; metals or metal alloys refined from regolith—such as iron, titanium, or aluminum; and polymers synthesized from volatiles present in permanently shadowed regions on the Moon, from atmospheric water and hydrocarbons in the case of Mars, recycled consumables, or from surface-cultivated biomass. In certain implementations, Earth-manufactured analogs of these materials—such as recycled metals, basalt-fiber composites, or regolith-simulant-based polymers—may be used to validate performance prior to off-world production. In extreme Earth environments, natural fibers or bio-derived polymers may be employed to tailor the geogrid to local conditions. This traceable-material strategy minimizes near-term logistical burden while establishing a direct pathway to long-term ISRU manufacturing capability.

In an exemplary embodiment optimized for lunar deployment, the geogrid is fabricated from aluminum or aluminum-based alloys which may be derived from regolith containing anorthite (CaAl₂Si₂O₈). The alloy may be surface-treated or anodized to reduce oxidation and dust adhesion while enhancing reflectivity and radiation tolerance. In some examples, the aluminum mesh is reinforced with small quantities of titanium or iron to improve mechanical stability, creep resistance, and corrosion performance. These properties enable the geogrid to maintain its geometry and interlocking function through repeated thermal cycles and continuous contact with abrasive regolith. The combination of ISRU-traceable composition, environmental durability, and manufacturability provides suitability for large-scale, in-situ fabrication and ensures long-term structural integrity under lunar surface conditions.

Manufacturing and Deployment Methods. The geogrid may be fabricated in situ in a variety of forms, including pre-formed sheets, rolled configurations, or through additive manufacturing, allowing adaptation to local site conditions and construction requirements. In-situ manufacturing reduces the logistical challenges of transporting large structural elements from Earth while enabling real-time customization to terrain, mission profile, or load-bearing needs. The geogrid may also be transported in compact, rolled, or folded configurations to minimize stowed volume, then unfurled, extended, or cut to length at the point of use. This packaging flexibility supports both extraterrestrial missions and rapid-deployment scenarios on Earth, such as desert stabilization, polar operations, or coastal reinforcement.

In some examples, the geogrid system is deployed using robotic dispensing systems, enabling infrastructure to be constructed autonomously or with minimal human assistance. This approach is particularly advantageous in hazardous or remote environments where human presence is limited or impractical. This approach enables the rapid construction of infrastructure in hazardous, remote, or low-gravity environments where manual assembly is impractical. Robotic deployment may further integrate sensing, feedback, and compaction tools to verify placement accuracy and substrate conformity during installation.

In some examples, the geogrid is arranged along an external vertical surface to confine the underlying regolith substrate. Methods can include upturning the edges of a horizontal geogrid to form a vertical surface, folding a two dimensional geogrid into a three dimensional form, or using pre-formed shapes such as buckets or cages as both reinforcement and formwork.

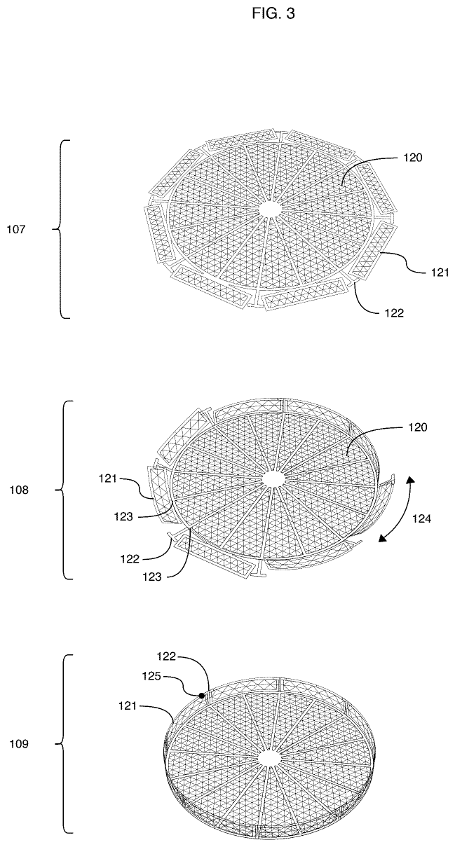

As illustrated in FIG. 3, a two-dimensional geogrid template (107) may be transformed into a three-dimensional form through controlled folding or upturning of its peripheral segments. The flat template includes a primary lattice (120), connecting tabs (122), and outer fold segments (121) connected along crease or hinge lines (123). In a partially transformed configuration (108), the fold segments are raised along these lines and bent as indicated by the directional arrows (124), forming continuous sidewalls or vertical confinement features around the central plane of the grid. The folded configuration (109) results in a shallow, bowl-like or tray-like geometry that can retain regolith, aggregate, or binder-modified mixtures while maintaining lateral stiffness. The folding process may be performed robotically or through a continuous forming apparatus, with optional welded connections (125) used to secure adjacent panels or lock the edges in the raised position. This approach allows flat, lightweight grid templates to be transported efficiently and converted in situ into rigid, three-dimensional structures that provide both surface reinforcement and volumetric confinement.

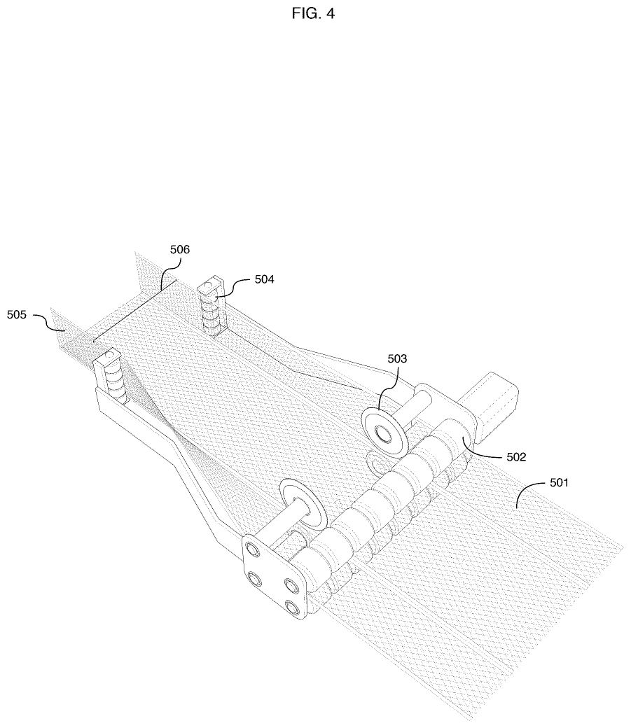

In an exemplary embodiment, a continuous geogrid structure is fabricated from flat sheet material using a progressive forming method. As illustrated in FIG. 4, feedstock (501), such as a metallic mesh sheet, is advanced through a series of drive rollers (502) that regulate feed rate and tension. The sheet then passes through a pair of contoured forming rollers (503) configured to crimp and fold the edges upward, thereby producing a continuous profile with upturned sidewalls (505). Edge guides (504) maintain alignment during forming, ensuring uniform geometry and preventing lateral drift of the material as it is shaped. Transverse cross-ties (506) may be added at regular intervals between approximately 5 cm and 15 cm to stabilize the upturned sidewalls and prevent outward deformation when the formed trays are filled and compacted with regolith.

This forming method provides an efficient means of producing lightweight, structurally reinforced geogrid elements suitable for on-site manufacturing or prefabrication. The resulting three-dimensional grid offers enhanced stiffness and confinement capability compared to planar mesh structures, while remaining compatible with autonomous or semi-autonomous deployment systems. The trays may subsequently be filled with regolith or regolith-binder mixtures, which can optionally be cured or reinforced along the edges to resist lateral buckling or blowout. This forming approach enables high-throughput, automated production of rigid, load-bearing geogrid elements directly from rolled feedstock. Alternative embodiments may employ discrete stamping or additive forming techniques, depending on material characteristics and mission constraints.

Geogrid Layering within Structures. The geogrid may be installed in multiple layers to form reinforced slopes, embankments, or other regolith-based structures. The vertical spacing, grid density, and number of layers may be adjusted according to local stress conditions and desired load-bearing capacity. In some examples, layer placement is fine-tuned to concentrate reinforcement where shear or tensile stresses are highest, while reducing layer density in low-stress regions to minimize material mass. This selective layering approach results in a structurally efficient configuration that resists anticipated loading while minimizing geogrid mass.

For instance, in high-stress regions, the spacing between successive geogrid layers may range from about 0.5 cm to about 2 cm, whereas in low-stress regions, the spacing may range from about 5 cm to about 15 cm, depending on the particle size, gravity, and overall scale of the structure. In larger embankments or structural foundations, layer spacing may exceed 20 cm where load demands are low. These ranges are illustrative and can be adjusted according to site-specific conditions, material stiffness, and compaction characteristics.

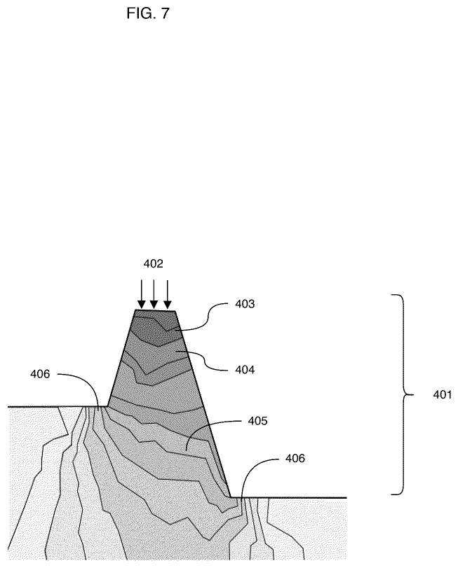

As illustrated in FIG. 7, a computational simulation (400), such as a Finite Element Analysis (FEA), may be used to evaluate a digital three-dimensional model (401) of a representative regolith embankment subjected to an applied load (402). The simulation environment or its graphical output produces stress contours identifying regions of high stress (403), average stress (404), and low stress (405), with localized stress concentrations (406) appearing near transition zones between vertical and horizontal components of the structure. These analytical results provide the design basis for determining grid density, material thickness, and vertical spacing of each layer to ensure optimal structural performance under expected loads and environmental conditions.

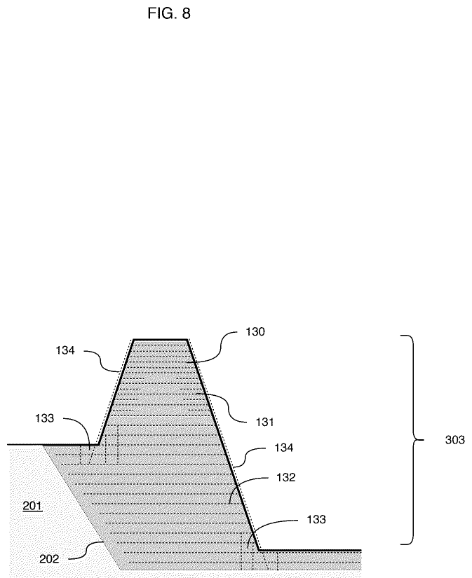

As illustrated in FIG. 8, the corresponding physical regolith embankment (303) is constructed in accordance with the simulation results, incorporating zones of varying geogrid layer density and orientation. The structure includes closely spaced geogrid layers (130) in high-stress regions near the crest and load-bearing zones, moderately spaced layers (131) in regions of average stress, and widely spaced layers (132) in lower-stress areas near the base or outer edges. The embankment is formed by first excavating bulk regolith (201) and then backfilling with restructured regolith (202), compacted together with successive geogrid layers. Each geogrid layer is upturned along its edge to form a continuous vertical confinement layer (133).

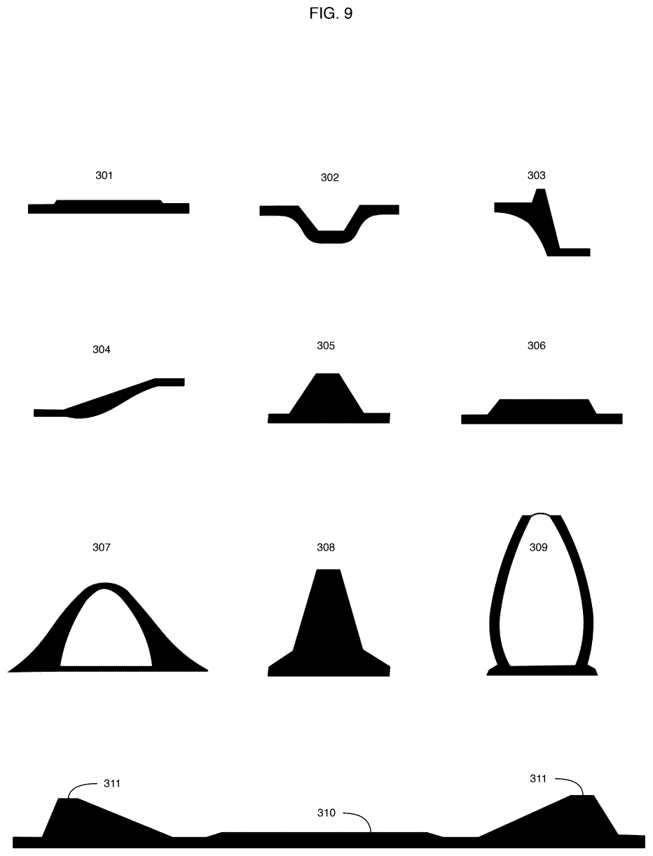

Exemplary Regolith-Based Infrastructure Applications. As illustrated in FIG. 9, the geogrid and regolith construction system may be used to fabricate a wide range of foundational infrastructures on extraterrestrial or extreme-Earth surfaces. Transportation and access infrastructure include roads (301) and utility trenches (302) that provide stable, graded surfaces for vehicle movement and subsurface routing of cables or conduits. Landscape stabilization structures, such as retaining walls (303) and ramps (304), may be constructed to manage elevation changes and maintain slope stability. Equipment and facilities infrastructure may include pedestals (305), prepared surfaces (306), and plinths (308) for supporting solar arrays, communication towers, or scientific instruments elevated above the surrounding terrain.

Habitation infrastructure focuses on protection and environmental control, including regolith overburden structures (307) used for radiation and micrometeorite shielding, and habitat shells (309) forming enclosed or partially enclosed living spaces. Launch and landing infrastructure includes reinforced landing pads (310) and berms (311) designed to absorb or redirect exhaust plume energy and ejecta during spacecraft operations. These examples collectively illustrate how regolith-derived materials and the described geogrid reinforcement system can be adapted to create integrated, multi-functional infrastructure supporting sustained surface operations.

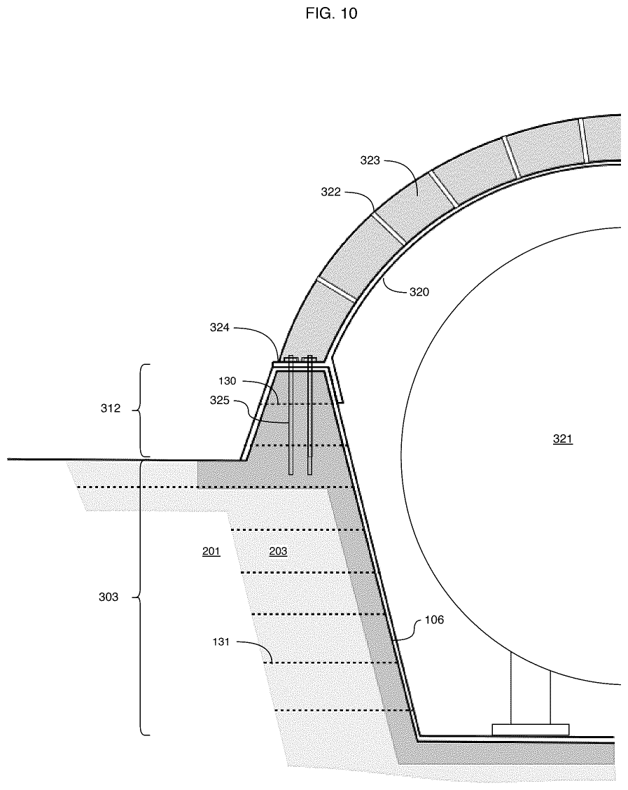

Exemplary Integration of Geogrid System. As illustrated in FIG. 10, the layered regolith and geogrid system may be integrated into a larger architectural assembly to provide structural support, load distribution, and environmental protection. In the illustrated example, a regolith embankment (303) supports an overlying vault (320) enclosing an interior volume (321). First, bulk regolith (201) is excavated then backfilled with restructured regolith (202) and compacted together with moderately spaced geogrid layers (131). A structural parapet (312) extends above the embankment, incorporating more closely spaced geogrid layers (130) to resist localized shear and settlement beneath the overlying structure. Each geogrid layer is upturned along its edge to form a continuous vertical confinement layer (133).

The vault (320) may be formed from prefabricated or in-situ-manufactured panels (322) with structural ribs (323) packed with regolith infill (324) for radiation shielding. At the interface, a spread footing (324) is connected with friction piles (325) extending into the upper regolith layers, mechanically coupling the vault to the embankment. This example demonstrates how the geogrid-reinforced regolith system can be holistically incorporated into broader architectural frameworks—such as foundations, berms, retaining structures, or protective vaults.

Although specific embodiments and examples have been described in detail, it will be understood that various modifications, substitutions, and alterations may be made without departing from the scope of the invention as defined by the appended claims. The principles of mass optimization, regolith restructuring, and autonomous deployment described herein may be applied in different combinations and configurations depending on environmental conditions, available materials, and mission requirements. Accordingly, the embodiments described above are intended to illustrate, not limit, the invention, and the true scope of the invention is defined by the following claims.

What is claimed is:

1. A geogrid system for stabilizing regolith or soil in extraterrestrial and extreme Earth environments,
wherein the geogrid structure is mass-optimized to enhance load-bearing and shear performance of granular substrates while minimizing material usage,
the mass optimization being achieved through geometry and material distribution tailored to local stress conditions and environmental factors.

2. The system of claim 1, wherein the geogrid comprises a mesh defining a repeating pattern of openings at a uniform or variable density to reduce mass, such as triangular or hexagonal lattices, square or circular cut-outs across its area.

3. The system of claim 1, wherein the geogrid includes reinforcing features comprising at least one of: corner braces, reinforced perimeters, collars surrounding openings, or bracing members connecting a perimeter to a collar.

4. The system of claim 1, wherein a mesh-window dimension of the geogrid is proportionally matched to a characteristic particle size of the substrate to promote mechanical interlock and increased shear resistance.

5. The system of claim 1, wherein the geogrid is fabricated from materials that are locally sourced or compositionally traceable to in-situ resource utilization (ISRU) processes, including metals or alloys refined from regolith, basalt fibers extruded from molten regolith, or polymers synthesized from volatiles or biomass.

6. The system of claim 1, wherein multiple geogrid layers are arranged in alternating sequence with compacted regolith layers, and layer spacing varies according to local stress conditions.

7. The system of claim 1, wherein the geogrid comprises a three-dimensional mesh formed by folding, bending, or otherwise shaping a two-dimensional geogrid sheet to create upturned edges, sidewalls, or cellular compartments that provide additional confinement or out-of-plane stiffness.

8. A method for stabilizing regolith or soil in extraterrestrial or extreme Earth environments, comprising the steps of:
(a) preparing a regolith substrate by sorting and compacting particles to achieve a controlled particle-size distribution;
(b) deploying a mass-optimized geogrid structure over or within the substrate to enhance load-bearing and shear capacity; and
(c) tailoring the geometry, material distribution, and layer spacing of the geogrid according to local stress conditions and environmental factors to minimize total mass while maintaining structural performance.

9. The method of claim 8, wherein preparing the regolith substrate comprises removing particles smaller than approximately 0.5 mm and reintroducing a portion of the removed fines to fill interstitial voids between larger particles, thereby increasing packing density and mechanical stability of the substrate.

10. The method of claim 8, wherein the restructuring of the regolith substrate produces a particle-size distribution that corresponds proportionally to a mesh-window dimension of the geogrid, such that the predominant particles bear against the window edges to create mechanical interlock and increased shear resistance.

11. The method of claim 8, wherein the deploying step comprises placing multiple geogrid layers in alternating sequence with compacted regolith layers, and adjusting the spacing between the layers in response to anticipated load conditions or internal stress gradients within the structure.

12. The method of claim 11, further comprising performing a finite element analysis (FEA) or equivalent computational modeling to identify regions of high and low stress within the structure, wherein the results of the analysis inform the spacing and density of the geogrid layers.

13. The method of claim 8, wherein the deploying step is performed autonomously or semi-autonomously by a robotic system configured to dispense, position, and interlock the geogrid with minimal human supervision.

14. The method of claim 8, further comprising forming the geogrid structure by advancing sheet material through contoured forming rollers that fold sheet edges upward to form sidewalls, thereby producing a continuous three-dimensional geogrid profile suitable for filling with regolith or regolith-binder mixtures.

15. The method of claim 8, wherein the regolith substrate includes a polymeric binder introduced locally to solidify the interface between regolith and geogrid in regions of concentrated load or across exposed surfaces.

16. The method of claim 8, wherein the geogrid-stabilized regolith forms part of an engineered surface architecture selected from the group consisting of landing and launch pads, graded embankments, access roads, structural foundations, retaining walls, and regolith overburden structures configured to shield or enclose pressurized modules.
